(19) United States
(12) Patent Application Publication
(10) Pub. No.: US 2007/0241654 A1
(43) Pub. Date: Oct. 18, 2007

(54) Lamp filament design

(76) Inventor: Robert Cassidy, Lebanon, NH (US)

Correspondence Address: EDWARDS ANGELL PALMER & DODGE LLP, P.O. BOX 55874, BOSTON, MA, 02205, US

(21) Appl. No.: 11/386,505

(22) Filed: Mar. 22, 2006

Related U.S. Application Data
(60) Provisional application No. 60/664,158, filed on Mar. 22, 2005.

(51) Int. Cl. H01J 1/88

(52) U.S. Cl. 313/271

(57) ABSTRACT

Disclosed is an electrode assembly for use in a lamp that includes, among other elements, a helical filament, and first and second electrode support wires. The helical filament has an inner coil conductor that includes at least first and second zones of pitch formed along its length and wherein the first zone of pitch is coiled at a first pitch, and wherein the second zone of pitch is coiled at a second pitch that is less than the first pitch. The first electrode support wire is welded to the filament in the first zone of pitch and the second electrode support wire welded to the filament in the second zone of pitch.

### BACKGROUND OF THE INVENTION

1. Field of the Invention

The present invention relates to an electrode assembly for use in a lamp and more particularly to a robust electrode assembly that includes a helical coil filament design having more than one zone of pitch in the coils and adapted for being welded to electrode support wires.

2. Background of Related Art

Fluorescent tube lamps are used in many applications due to their desirable characteristics. These lamps include a sealed, phosphor-coated vitreous tube, along with a drop of mercury, some of which is in vapor form. Electrode assemblies at either end of the tube are electrically connected with electrically conductive pins extending externally from either end of the tube. These pins electrically communicate with corresponding electrical contacts associated with the lamp fixture for which the fluorescent tube lamp is intended.

The electrode assemblies within the tube typically comprise filament electrodes supported within the sealed tube and coated with emissive materials which emit electrons. In operation, an alternating current is applied to the pins through the lamp fixture contacts. The voltage across the filament electrodes increases the temperature and results in the emission and migration of electrons through the tube. As electrons move through the tube, they collide with the gaseous mercury atoms. These collisions excite the atoms, bumping electrons up to higher levels. When the electrons return to their normal energy level, they release light photons, primarily in the ultraviolet range. The phosphor coating on the tube absorbs the ultraviolet light, causing the phosphor to fluoresce and emit visible light.

Filament electrodes are typically constructed in what is referred to in the industry as triple coil, stick coil or coil-coil versions. All three of these traditional designs have a current carrying wire. The purpose of which is to carry the filament heating current and provide intimate contact to the emission coating which covers this wire. The triple coil and stick coil have a very fine wire which is wrapped around the current carrying wire also called a basket wire. The purpose of the basket wire is to facilitate holding more emission coating in contact with the current carrying wire. U.S. Pat. No. 6,809,477 to Soules et al. and U.S. Pat. No. 4,316,116 to Graves et al. provide descriptions of various filament constructions, including a triple coil construction, and are each herein incorporated by reference in their entireties.

In all of these designs the current carrying wire/filament is wrapped around a molybdenum mandrel and in effect the current carrying wire looks like a spring with a standard pitch (i.e., the spacing between the turns of the current carrying wire). Prior to attaching the filament to the electrode support wires, the mandrel or portions thereof is removed or chemically dissolved.

Attempts have been made to weld the helical current carrying wire and basket wire to electrode support wires in electrode assemblies. While welding provides electrical contact between the filament and the electrode support wires, as well as ease of manufacture, it can lead to sharp bends in the coils including folding the coils onto each other. This results in a weakened mechanical structure that leads to filament breakage.

It is also known in the art to crimp the coils into the electrode support wires, rather than welding. One reference in particular, U.S. Pat. No. 6,465,939 to Ward and Cassidy, teaches clamping the filament around a mandrel into each of the electrode support wires. This design has the advantage of mechanical strength, leading to less filament breakage, but does not yield the electrical connection and ease of manufacture possible with welding.

Since the coils of the filament electrode and any associated wires are relatively delicate, the life span of fluorescent lamps is often cut short by filament breakage. This causes additional unanticipated lamp replacement and associated maintenance costs, especially when these lamps are used in high vibration environments, such as avionics. Thus, what is needed is a lamp having an electrode assembly of greater structural integrity, durability, electrical connection, and ease of manufacture than prior art lamps.

### SUMMARY OF THE INVENTION

The purpose and advantages of the present invention will be set forth in and apparent from the description that follows, as well as will be learned by practice of the invention. Additional advantages of the invention will be realized and attained by the methods and systems particularly pointed out in the written description and claims hereof, as well as from the appended drawings.

The present invention improves upon and solves the problems associated with the prior art by providing, among other things, a system and method for constructing a filament electrode for use in a fluorescent lamp which is of greater structural integrity and higher efficiency than the prior art.

To achieve these and other advantages and in accordance with the purpose of the invention, as embodied herein and broadly described, the invention includes a helical filament having an inner coil conductor that includes a first and second zone of pitch. The first zone of pitch is coiled at first pitch, and the second zone of pitch is coiled at a second pitch, which is less than the first pitch. The filament is welded in the first zone of pitch to a first electrode support wire. The filament is also welded to the filament in the second zone of pitch to a second electrode support wire.

In accordance with a further aspect of the invention, a transition zone is provided between the first and second zones of pitch. The pitch in the transition zone varies smoothly from the first pitch to the second pitch.

In accordance with another aspect of the invention, the filament is provided that further includes an outer coil conductor wound around the inner coil conductor. In another aspect, the filament can include a third level of coiling. In yet another aspect, the filament can be in a stick coil configuration.

In accordance with yet another aspect of the invention, the electrode assembly can be configured and adapted for use in a fluorescent lamp. In yet another aspect, the lamp can be a fluorescent lamp that operates at greater than 800 milliamps.

The invention also includes an electrode assembly for use in a lamp including a helical filament having an inner coil conductor that includes first, second, and third zones of pitch. The first zone of pitch is coiled at a first pitch. The second zone of pitch is adjacent to the first zone of pitch and is coiled at a second pitch that is less than the first pitch. The third zone of pitch is adjacent to the first zone of pitch and is coiled at a third pitch that is less than the first pitch. The electrode assembly also includes a first electrode support wire welded to the filament in the second zone of pitch and a second electrode support wire welded to the filament in the third zone of pitch. In with one embodiment of the invention, the second and third pitches can be equal.

In further accordance with the invention, the filament can further include a first transition zone between the first and second zones of pitch, in which the pitch transitions smoothly from the first pitch to the second pitch. Also, the filament can include a second transition zone between the first and third zones of pitch, in which the pitch transitions smoothly from the first pitch to the third pitch.

In accordance with a further aspect of the invention, the filament can be in a coil-coil configuration.

In accordance with yet another aspect of the invention, the filament can include an outer coil conductor wound around the inner coil conductor. In one embodiment of the invention, the filament can include a third level of coiling. In another embodiment, the filament can include a stick coil configuration.

In accordance with still another aspect of the invention, the electrode assembly can be configured and adapted for use in a fluorescent lamp. In one embodiment, the lamp can operate at greater than 800 milliamps.

It is to be understood that both the foregoing general description and the following detailed description are exemplary and are intended to provide further explanation of the invention claimed.

The accompanying drawings, which are incorporated in and constitute part of this specification, are included to illustrate and provide further understanding of the electrode assembly of the invention. Together with the description, the drawings serve to explain the principles of the invention.

### BRIEF DESCRIPTION OF THE DRAWINGS

So that those having ordinary skill in the art to which the disclosed device appertains will more readily understand how to make and use the same, reference may be had to the drawings wherein:

FIG. 1 is a perspective view of a filament conductor which is constructed in accordance with an embodiment of the present invention illustrating different zones of pitch, among other things;

FIG. 2 is a perspective view of an electrode assembly constructed in accordance with an embodiment of the present invention shown in its contact position with two conductive electrode support wires prior to being mounted thereon and sealed in a vitreous tube of a fluorescent lamp;

FIG. 3 is an enlarged perspective view of the electrode assembly of FIG. 2 illustrating the mounting of the filament onto an electrode support wire; and

FIG. 4 is a perspective view of the electrode assembly shown in FIG. 2 after mounting the opposing ends of the filament on the two electrode support wires.

These and other features of the subject invention will become more readily apparent to those having ordinary skill in the art from the following detailed description of preferred embodiments.

### DETAILED DESCRIPTION OF THE PREFERRED EMBODIMENTS

Reference will now be made in detail to preferred embodiments of the present invention, an example of which is illustrated in the accompanying figures. The figures and detailed description are provided to describe and illustrate examples in which the disclosed subject matter may be made and used, and are not intended to limit the scope thereof.

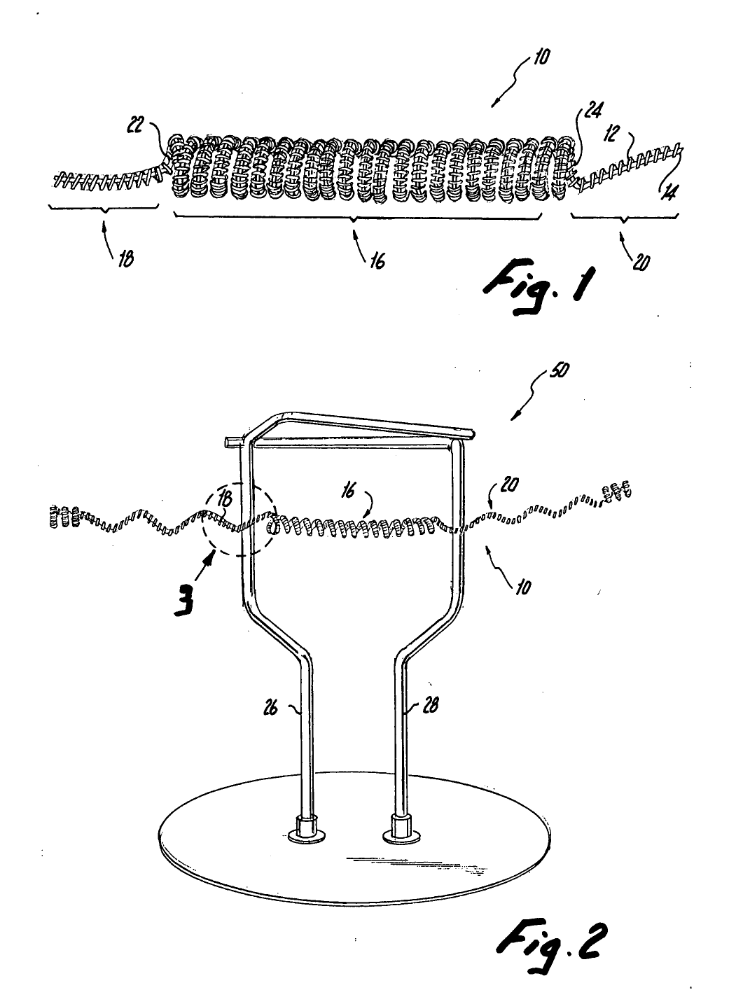

Referring now to the FIGS. 1 through 4, which illustrate an electrode assembly which has been constructed in accordance with a preferred embodiment of the present invention and designated by reference numeral 50. Electrode assembly 50 includes a filament electrode 10, a first electrode support wire 26 and a second electrode support wire 28.

Filament electrode 10 includes a outer conductor 12 (basket wire) coiled about an inner coil conductor 14 (current carrying wire) having zones of different pitch. Conductors 12 and 14 are both coated with emissive materials. Current carrying wire 14 includes a central first region 16 having a higher pitch and turns per inch than end regions 18 and 20. The pitch and turn per inch change between first region 16 and the end regions 18 and 20 occurs in transition portions 22 and 24.

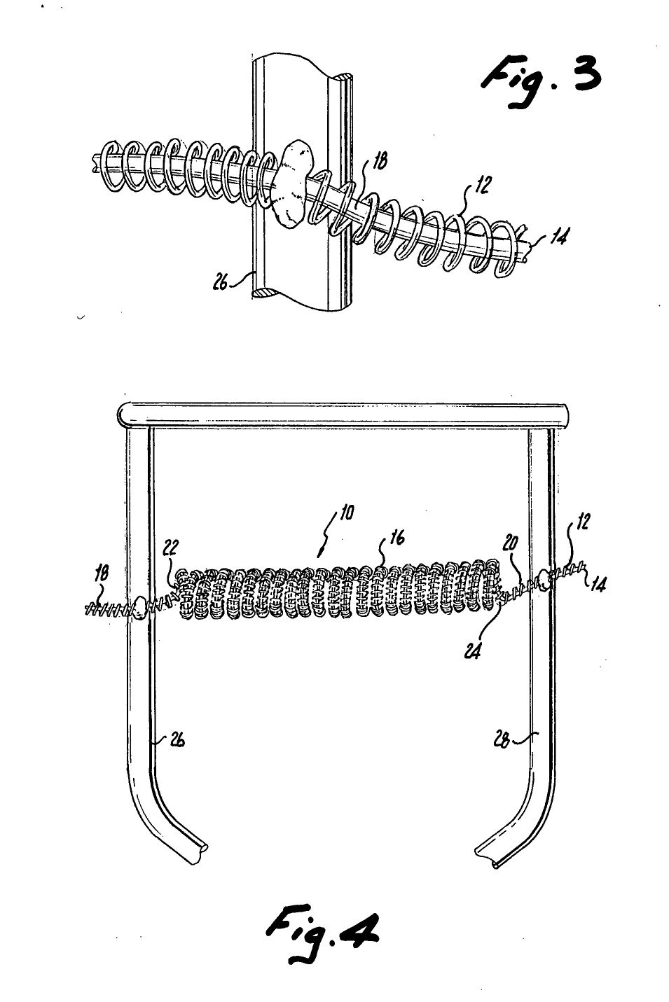

As shown in FIGS. 3 and 4, end regions 18 and 20 are welded to the first electrode support wire 26 and the second electrode support wire 28, respectively. The resulting filament electrode 10 has current carrying wire 14, with or without the basket wire 12 thereon, sticking out relatively straight or with a very wide spacing. One of the advantages of such a design is that the opposing ends of filament electrode 10, and in particular, the opposing ends of current carrying wire 14, provide for excellent welding locations that can be welded to the first and second electrode support wires 26 and 28 without causing damage to filament electrode 10, which typically occurs in the prior filament method of construction and attachment.

In prior art constructions, the filament electrode has a uniform pitch along its length and when welded to the electrode support wires, the shape and pitch of basket wire and current carrying wire are significantly altered by the welding. For example, the individual rings of basket wire and current carrying wire are brought into closer proximity or even contact with one another. This change weakens the structure of filament electrode, making it prone to breakage, as well as reduces its overall efficiency.

In the present design, the opposing ends 18/20 or tails of filament electrode 10, or more preferably, the tails of current carrying wire 14, are pulled and the design welds better than in prior art filament electrodes. The manufacturing problems that existed in the prior art are eliminated by the present invention. It is speculated that the present invention would advantageously be of great benefit for lamps operating at greater than 800 milliamps.

The present invention is directed to a robust fluorescent lamp filament electrode that is also particularly suitable for high vibration environments. Accordingly, the present invention greatly improves lamp life in such high vibration environments, among other things. This is especially important in many critical applications such as for use in avionics. Additionally, while the present invention has been illustrated with respect to a triple coiled type filament electrode, the present invention may be applied equally well to any coiled filament electrode. Therefore, although an exemplary embodiment has been illustrated and described, it will be obvious to those skilled in the art that various modifications of the embodiment depicted herein may be made without departing from the spirit and scope of this invention.

It is also to be understood that the system and method of the present invention may be advantageously employed without the incorporation of each of the features disclosed herein. It is to be further understood that modifications and variations may be utilized without departure from the spirit and scope of this inventive system and method, as those skilled in the art will readily understand. Such modifications and variations are considered to be within the purview and scope of the present invention described herein.

What is claimed is:

1. An electrode assembly for use in a lamp comprising:
a) a helical filament having an inner coil conductor that includes at least first and second zones of pitch formed along its length and wherein the first zone of pitch is coiled at a first pitch, and wherein the second zone of pitch is coiled at a second pitch that is less than the first pitch;
b) a first electrode support wire welded to the filament in the first zone of pitch; and
c) a second electrode support wire welded to the filament in the second zone of pitch.

2. The electrode assembly of claim 1, wherein the helical filament further comprises a transition zone arranged between the first zone of pitch and the second zone of pitch, so as to smoothly transition the first pitch of coils to the second pitch of coils.

3. The electrode assembly of claim 1, wherein the filament comprises a coil-coil configuration.

4. The electrode assembly of claim 1, wherein the filament further comprises an outer coil conductor wound around the inner coil conductor.

5. The electrode assembly of claim 4, wherein the filament is constructed as a triple coil configuration.

6. The electrode assembly of claim 4, wherein the filament comprises a stick coil configuration.

7. The electrode assembly of claim 1, wherein the lamp is a fluorescent lamp.

8. The electrode assembly of claim 7, wherein the lamp operates at greater than 800 milliamps.

9. An electrode assembly for use in a lamp comprising:
a) a helical filament having an inner coil conductor that includes first, second, and third zones of pitch wherein the first zone of pitch is coiled at a first pitch, and wherein the second zone of pitch is adjacent to the first zone of pitch and is coiled at a second pitch that is less than the first pitch, and wherein the third zone of pitch is adjacent to the first zone of pitch and is coiled at a third pitch that is less than the first pitch;
b) a first electrode support wire welded to the filament in the second zone of pitch; and
c) a second electrode support wire welded to the filament in the third zone of pitch.

10. The electrode assembly of claim 9, wherein the second pitch is equal to the third pitch.

11. The electrode assembly of claim 9 wherein the filament further comprises a transition zone positioned between the first zone of pitch and the second zone of pitch, so as to smoothly transition from the first coil pitch to the second coil pitch.

12. The electrode assembly of claim 9, wherein the filament is constructed in a coil-coil configuration.

13. The electrode assembly of claim 9, wherein the filament further comprises an outer coil conductor wound around the inner coil conductor.

14. The electrode assembly of claim 9 wherein the filament is constructed in a triple coil configuration.

15. The electrode assembly of claim 9 wherein the filament is constructed in a stick coil configuration.

16. The electrode assembly of claim 9 wherein the lamp is a fluorescent lamp.

17. The electrode assembly of claim 9 wherein the lamp operates at greater than 800 milliamps.

18. An electrode assembly for use in a fluorescent lamp comprising:
a) a triple coil filament having an inner coil conductor and a basket wire wrapped around the inner coil conductor, wherein the triple coil filament includes first, second, and third zones of pitch with the first zone of pitch being coiled at a first pitch, the second zone of pitch being adjacent to the first zone of pitch and being coiled at a second pitch that is less than the first pitch, and the third zone of pitch being adjacent to the first zone of pitch and being coiled at a third pitch that is less than the first pitch;
b) a first electrode support wire welded to the filament in the second zone of pitch; and
c) a second electrode support wire welded to the filament in the third zone of pitch.
